(19) United States
(12) Patent Application Publication
(10) Pub. No.: US 2024/0427564 A1
(43) Pub. Date: Dec. 26, 2024

(54) SYSTEMS AND METHODS FOR CODE DEVELOPMENT WITH GENERATIVE ARTIFICIAL INTELLIGENCE

(71) Applicant: OSF Global Services, Inc., Wilmington, DE (US)

(72) Inventors: Simion Petrov, Madrid (ES); Mónica Pastor Fernández, Madrid (ES); Douglas Matos de Souza, Rio Grande do Sul (BR); Daniel-Stefan Anechitoaie, Neamt (RO)

(73) Assignee: OSF Global Services, Inc., Wilmington, DE (US)

(21) Appl. No.: 18/743,659

(22) Filed: Jun. 14, 2024

Related U.S. Application Data
(60) Provisional application No. 63/522,746, filed on Jun. 23, 2023.

(51) Int. Cl. G06F 8/33; G06F 8/35; G06F 8/71

(52) U.S. Cl. CPC G06F 8/33; G06F 8/35; G06F 8/71

(57) ABSTRACT

Software code development and quality assurance through generative Artificial Intelligence systems and methods that streamline continuous integration and continuous deployment (CI/CD) pipelines without increasing review or development durations.

### BACKGROUND INFORMATION

### Field of the Disclosure

Examples of the present disclosure are related to systems and methods for high-quality and efficient code development processes utilizing generative artificial intelligence. Specifically, embodiments are related to software code development and quality assurance that streamlines continuous integration and continuous deployment (CI/CD) pipelines to decrease review and development durations.

### Background

Conventionally, to update or develop code for software applications, the updated code is written according to a plan created in a planning phase. This involves writing the code, testing the code locally, and making any necessary changes to ensure that the code meets the requirements of the planning phase. Once the code is written, the code is reviewed by code reviewers to ensure the quality of the code, wherein the review process can include checking the code for errors, security vulnerabilities, and adherence to coding standards. Once the issues with the code are resolved and the code meets the requirements, the code may be approved and moved to the testing phase.

In the testing phase, CI/CD pipelines are used to merge code changes into a shared repository and run automated tests to detect any issues. The tested code can then be released to production environments.

Utilizing version control systems, developers can keep track of changes made to the code for the software applications over time, collaborate with other developers on the same codebase, and revert to previous versions of the code if necessary. Version control systems provide a centralized repository where all changes to the code are stored, along with information about who made the changes and when they were made. Version control systems also reduce the risk of errors and conflicts when multiple developers are working on the same codebase, and allow developers to work on their branches of the code. The branches of code can be merged back into the main codebase once the changes have been reviewed and approved.

Conventionally, to develop, review, test, and deploy code requires long quality assurance tests, which require both software developers and code reviewers. This improves the quality of the code but makes the review process longer, increasing the processing time. Additionally, these quality checks, when manually performed, lead to a higher rate of failure, resulting in lower code quality with lower server performance, and higher maintenance costs. While prior solutions have streamlined specific steps in the process, such as bug scanning and quality reports, these prior solutions do not fully address the issues related to processing time, server performance, and maintenance costs that were previously mentioned.

Accordingly, needs exist for more efficient and effective systems and methods that leverage a generative Artificial Intelligence (AI) system to add quality assurance to the software development and code review process without increasing its duration, while also streamlining CI/CD Pipelines.

### SUMMARY

Embodiments described herein are directed towards systems and methods that leverage a generative Artificial Intelligence (AI) system to add quality assurance to the software development and code review process to streamline CI/CD pipelines by decreasing their duration. Specific embodiments are directed towards increasing code quality by documenting the code, adding unit tests, fixing bugs, refactoring the code, analyzing the risks of change requests, etc. Higher code quality leads to less network bandwidth usage when communicating with a server because fewer call requests and storage requirements are needed. Well-designed code can load data selectively based on user actions or requirements, rather than loading all possible data upfront. This can greatly reduce initial and ongoing bandwidth usage.

Embodiments use Large Language AI models to perform computer-based tasks that augment and/or supplement the work of software developers and reviewers, which generally decrease processing time by saving code development and review time. Additionally, embodiments may improve the overall quality of the code, which will increase server performance and reduce maintenance costs as less bandwidth is required to communicate with the server and less processing power is required to update the server.

The maintenance and storage costs of computer servers can be reduced by improving the quality of code, which in turn increases server performance.

Computer applications, in this context referred to as a “client,” has its own front-end code that manages the user interface and user interactions. The network serves as the medium through which the client and server communicate. Data is transmitted across the network from the client to the server, often using protocols such as HTTP/HTTPS. Higher code quality can lead to less network bandwidth usage when communicating with a server.—Because embodiments may create higher-quality code, embodiments may implement intelligent caching strategies that store frequently accessed data on the client side, reducing the need for repeated requests to the server for the same data. Furthermore, embodiments may reduce unnecessary communication with the server by resolving issues on the client side where possible, rather than relying on server-side processing to handle every exception.

The server is a remote computer that receives the data from the client, handles business logic, data processing, and communication with databases or other services. When the code quality is higher, the processing of the server can be faster because higher-quality code is more likely to be efficient, well-optimized, and free of performance bottlenecks that can slow down server processing.

The server communicates with a database through a database management system (DBMS), which typically occurs over a network. The server utilizes a specific protocol or API (Application Programming Interface) provided by the DBMS to perform CRUD (Create, Read, Update, Delete) operations in the database. When the code interacts with APIs, high-quality implementations can make use of efficient API calls that request only the data needed at that time, rather than fetching large datasets that include unnecessary information. This higher quality code may require less processing power required to update the database.

Embodiments may document the code upon the code being placed on a pipeline by adding docstrings and comments to the code, reducing the effort required for maintainability. AI may prepare the code on the pipeline for human review by analyzing the content of a pull request, wherein a pull request is associated with a piece of code to be added to the database without merging the code. The AI analysis may include determining potential issues and vulnerabilities before the code is compiled or deployed. The results of the analysis, along with a static code analysis are used to identify logic, functionality, and security bugs. Upon identifying the bugs, the AI may suggest fixes and coding best practices. Additionally, the AI may generate unit test drafts to ensure high test code coverage.

Embodiments may utilize the AI to analyze the risks of the identified bugs and to refactor the pieces of code with lower-risk bugs, which fine-tunes the review process. Embodiments may utilize the AI to analyze the pull requests and classify the pull requests by confidence level. Pull requests with high-confidence level contain code with low-risk bugs that can be refactored. Pull requests with low-confidence level contain code with medium and high-risk bugs that need to be reviewed by code reviewers and refactored by developers. Subsequently, embodiments of the AI may approve the pull requests that have high confidence metrics and generate a summary, using natural language, of the rest of the pull requests, reducing the review time. Finally, embodiments of the AI may generate periodic release notes that detail all changes made to the code database, improving quality and maintainability.

To this end, the code development review and pipeline may leverage artificial intelligence to allow code associated with software applications to be developed, reviewed, and augmented by the generative artificial intelligence in parallel to a human reviewer reviewing the code and the human developer developing the code, which may reduce production time to update software applications. Embodiments may further increase server performance and improve code quality by performing quality assurance steps such as addressing logic and functionality issues, increasing processing speed, decreasing memory usage, and lowering energy consumption. This is because better-quality code requires fewer changes to perform the same tasks, resulting in more efficient and streamlined processes. Also, embodiments may reduce development maintenance costs of the server hosting the codebase improving the code quality by performing quality assurance steps, such as finding security issues, logic and functionality mistakes, generating unit tests, and release notes. These may reduce the amount of memory required to implement CI/CD pipelines.

Also, software developers and code reviewers can increase productivity and save time on documenting, reviewing, and debugging code. This can reallocate time towards higher quality code, faster development, and review times, and ultimately, better products, increased customer loyalty, and faster go-to-market.

This approach increases the speed of development and also reduces the likelihood of errors. As features and capabilities are shipped faster to the software app users, this will increase revenue and/or improve the user experience. Additionally, fewer defects in the code may result in an enhanced quality of the system, improved user experience, and educe the resources spent on customer support and maintenance. The Total Cost of Ownership of the software system using embodiments may be reduced due to lower costs for quality assurance, documenting the code, and onboarding new maintenance team members.

These, and other aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present embodiments are described concerning the following figures, wherein reference numerals refer to like parts throughout the various views unless otherwise specified.

FIG. 1 depicts one topology for code development processes utilizing artificial intelligence.

FIG. 2 depicts an AI computing device, according to embodiments.

FIG. 3 illustrates a method for a production line of code that leverages AI, according to an embodiment.

FIG. 4 depicts processes implemented by an AI computing device, according to an embodiment.

FIG. 5 depicts AI computing device determining a docstring missing and suggesting docstring for code on a pipeline, according to an embodiment.

FIG. 6 depicts AI computing device determining a bug and determining a fix for the bug for code on a pipeline, according to an embodiment.

FIG. 7 depicts one topology for code development processes utilizing artificial intelligence.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific details need not be employed to practice the present invention. In other instances, well-known materials or methods have not been described in detail in order to avoid obscuring the present invention.

The underlying computer problem addressed by embodiments is the high server maintenance and storage costs associated with any application. This process is an overall enhancement to business operations (CI/CD Pipelines) by modifying some steps and incorporating additional ones, going beyond purely automating a process. While other prior AI solutions focus on replacing or augmenting the application itself by integrating capabilities into the User Interface (UI), such as summarizing existing data from the database, embodiments leverage CI/CD pipelines to improve server efficiency without altering the enterprise applications themselves.

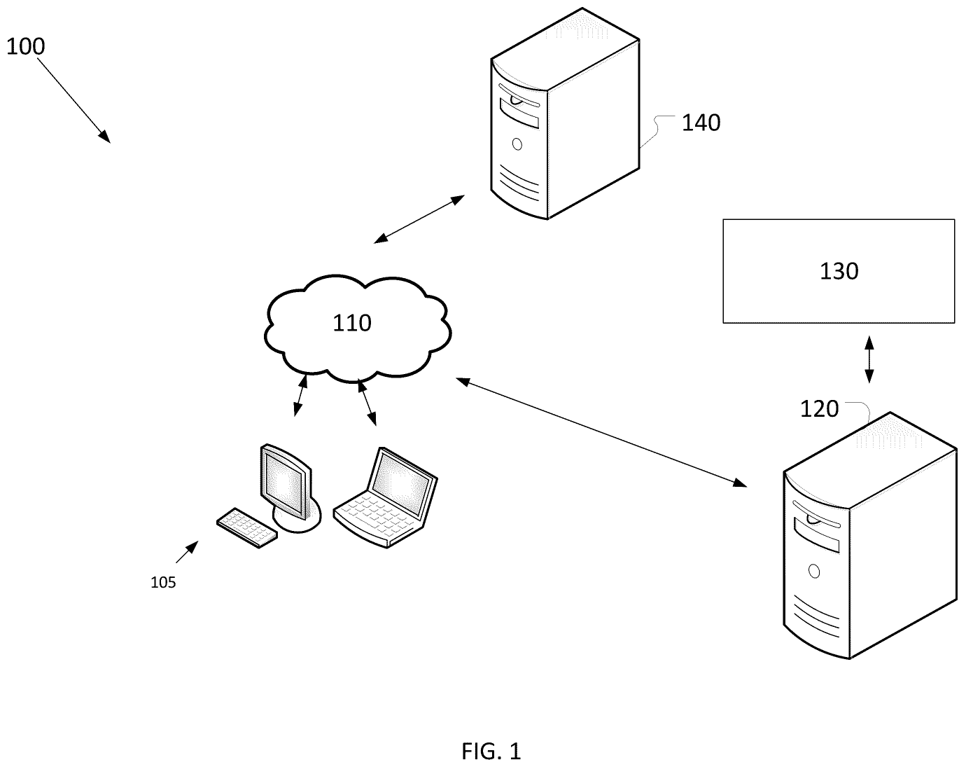

Turning now to FIG. 1, FIG. 1 depicts one topology for code development processes utilizing artificial intelligence. Embodiments may be configured to drive effective and efficient utilization of AI, allowing for more efficient code development to a codebase. Topology 100 may include developer and review computing devices 105 for developing and reviewing code, server 120 that is configured to store repositories 130 associated with tested code, and AI computing device 140, which are configured to be communicatively coupled over network 110.

Network 110 may be a wired or wireless network such as the Internet, an intranet, a LAN, a WAN, a NFC network, Bluetooth, infrared, radio frequency, a cellular network or another type of network. It will be understood that network 110 may be a combination of multiple different kinds of wired or wireless networks which may communicate data associated with updating and/or creating new code.

Computing devices 105 may be a tablet computer, laptop computer, a computer, personal data assistant, or any other type of device with a hardware processor that are configured to process instructions and connect to one or more portions of network 110. Computing devices 105 may have a graphical user interface that is configured to allow a user to interact with a processor of client computing device 105 to create and/or update code. In embodiments, the code and corresponding work product may be transmitted to server 120 over network 110. Computing devices 105 may be utilized by code developers to develop code, and by code reviewers to review the code. In embodiments, the developers and reviewers may review code that has been augmented, updated, and/or documents by AI computing device 140. Responsive to approving code for updating, computing devices 105 may transmit the approved code to server 120 where the approved code can be stored within codebase repositories 130.

Server 120 may be a computing resource that is configured to remotely provision, allocate, manage, and codebase repositories 130 associated with software applications to execute the software applications. Server 120 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Server 120 may include any combination of one or more computer-usable or computer-readable media. For example, server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Repositories 130 may be databases storing branches of code for software applications. The repositories 130 may be configured to be updated via AI computing devices 140 approving code automatically, and/or developers or reviewers approving code utilizing computing devices 105. This may allow for the codebase stored within repositories 130 to be updated via multiple paths on a pipeline. Embodiments may leverage well-designed code avoids unnecessary database operations, such as redundant queries or updates associated with repositories 130. This minimizes the work the database server has to do. Furthermore, the higher-quality code may interact with a well-normalized database, where data redundancy is minimized and data integrity is maintained. This can lead to more efficient updates of repositories 130 because there is less duplicated data to manage.

AI computing device 140 may include hardware processors that are configured to process instructions and connect to one or more portions of network 110. In embodiments, AI computing device 140 may be a cloud-based computing device coupled to multiple computing devices 105 and/or server 120 that leverage large language models to supplement the code development process. AI computing device 140 may have interfaces that are configured to allow a user to interact with a processor of AI computing devices 140 to perform tasks associated with creating and/or updating code. In embodiments, AI computing devices 140 may be located remotely or at the same locations as computing device 105 and/or server 120. In embodiments, AI computing devices 140 may be any type of computing device that is configured to leverage AI systems to perform tasks. For example, AI computing devices 140 may be configured to increase the quality and efficiency of code developed and reviewed with computing devices 105, while streamlining CI/CD pipelines using Large Language Models (LLM) technology.

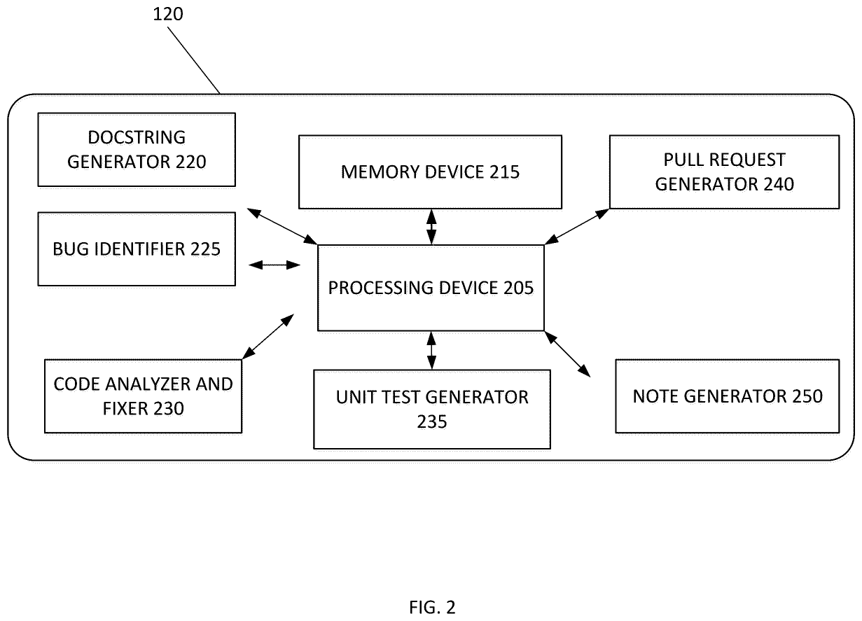

FIG. 2 depicts an AI computing device 140, according to embodiments. Elements depicted in FIG. 2 may be described above, and for the sake of brevity a further description of these elements may be omitted. Specifically, AI computing device 140 may utilize Large Language Models (LLMs) in CI/CD pipelines, employing DevOps concepts to automate and enhance the quality of the software development process. The language models within AI computing device 140 may been adapted for use in software development, although the languages may be originally designed to be more generic and less specialized. AI computing device 140 may be configured to interact with all stages of the code development and review process, revolutionizing the way code is created, reviewed, deployed, and integrated.

AI computing device 140 may include a processing device 205, a communication device 210, a memory device 215, docstring generator 220, bug identifier 225, code analyzer and fixer 230, unit test generator 235, pull request approver and summarizer 240, and note generator 250.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of AI computing device 140 or software associated with other elements of AI computing device 140.

Communication device 210 may be a device that allows AI computing device 140 to communicate with another device over network 130. Communication device 210 may include one or more wired/wireless transceivers for performing wireless communication over network 110. Communication device 210 may be configured to receive data from computing devices 105 associated with updated code, and transmit data associated with the updated code to the computing devices 105. In embodiments, communication device 210 may be configured to receive code to be reviewed on various programming languages and environments, improving the efficiency and quality of the code development and review process.

Memory device 215 may be a device that stores data generated or received by AI computing device 140. Memory device 215 may include, but is not limited to a hard disc drive, an optical disc drive, and/or a flash memory drive. In embodiments, memory device 215 may be configured to store information received from a computing device 105 and information associated with large language models. Memory device 215 may also be configured to store data associated with received code, data associated with machine learning, etc. For example, memory device 215 may be configured to receive code to update from a computing device 105, and store the updated code after AI computing device 140 processes the code. Furthermore, when processing device 205 utilizes machine learning to update and/or approve code, processing device 205 may update the large language models stored on memory device 215.

Docstring generator 220 may be a computing device that is configured to analyze changes to code and insert missing documentation into the code. For example, docstring generator 220 may be configured to add docstring and comments to the code. Docstring generator 220 may save computing resources in several ways: writing docstrings faster than developers, thus consuming less CPU usage, reducing the bandwidth required to transfer data since the documentation is written directly in the centralized repository, and reducing overall memory and CPU usage within a development team by reducing the need for repetitive manual tasks, freeing up developers to work on more resource-intensive tasks.

Bug identifier 225 may be a hardware computing device that is configured to analyze the code without executing the code. In embodiments, when analyzing the code, bug identifier 225 may determine potential issues and vulnerabilities associated with the code before the code is compiled or deployed. If bug identifier 225 determines there are issues with the code, bug identifier 225 may determine fixes and best practices. In embodiments, bug identifier 225 may be configured to suggest fixes to the code based on Git-based version control systems hosted on a remote repository or database. Bug identifier 225 may save computing resources in several ways: increasing the speed of software development lifecycle efficiency by catching and fixing defects before they reach the central code repository, saving many resources, including human effort, CPU, memory and networking bandwidth; reducing network usage by reducing necessary interactions between local repository and central repository when fixing defects; and preventing suboptimal software to pushed to the centralized repository and going to production by catching defects early, saving CPU, memory and storage.

Code analyzer and fixer 230 may be a hardware computing device that is configured to analyze the code by executing the code and determine potential security issues and runtime inefficiencies. Further, code analyzer and fixer 230 may be configured to determine risks of the potentially security issues, and automatically refactor pieces of code with lower risks. Code analyzer and fixer 230 may save computing resources in several ways: reducing the time of the interaction needed between the central repository and local repository by fixing low risk defects; ensuring that no suboptimal code reaches the central repository, thus increasing the efficiency of the software running in production and saving CPU usage; and reducing network usage by reducing necessary interactions between local repository and central repository when fixing defects.

Unit test generator 235 may be a hardware computing device that is configured to generate unit test drafts with high code coverage. Unit test generator 235 may save computing resources in several ways: rapidly creating test suites for untested code that otherwise would require for hours of human work, wasting computing resources, like CPU and Networking, reducing the bandwidth required to transfer data since the unit tests are written directly in the centralized repository; helping on finding defects by generating unit tests, thus increasing the efficiency of the software running with less defects and saving computing resources, like memory, CPU and storage; and ensuring that all code pushed to the central repository will contain unit tests, thus providing a standardized code based with unit tests, saving time be requiring less human efforts to review and update tests, saving CPU and Memory.

Pull request approver and summarizer 240 may be a hardware computing device that classifies pull requests by confidence level, and approves pull requests that have high levels of confidence. Pull request approver and summarizer 240 may save computing resources when summarizing pull requests in several ways: creating pull request summaries faster than developers, thus consuming less CPU usage; reducing overall memory and CPU usage within a development team by reducing the need for repetitive manual tasks, freeing up developers to work on more resource-intensive tasks; ensuring consistent summaries by following specific patterns due to Artificial Intelligence training, while a developer may include varying amounts of information causing inconsistencies that lead to increased processing time and resources when reviewing changes; generating concise, relevant summaries using natural language processing techniques, thus reducing the amount of memory needed to store and transmit the information; and improving summaries over time by learning from previously generated summaries, which leads to even more efficient use of resources. Additionally, pull request approver and summarizer 240 may save computing resources when approving pull requests in several ways: reducing the time spent waiting for review and approval of pull requests by processing and analyzing code changes quicker than developers; maintaining a consistent level of review quality regardless of the number of pull requests it handles, unlike developers who may become fatigued or distracted leading to less accurate reviews and wasted computing resources; reducing the likelihood of human errors during code review, minimizing the need for expensive compute resources to handle bugs, crashes, or other issues related to incorrect approvals, concurrently reviewing multiple pull requests, eliminating potential bottlenecks when there's a high volume of changes to be reviewed by a limited number of developers; identifying resource-intensive code before it is merged, allowing for optimization and preventing potential resource drain during execution; prioritizing and bundle pull requests more efficiently, optimizing bandwidth usage in cases where team members are working remotely or in distributed environments; and optimizing its decision-making process to reduce resource waste across numerous reviews by learning from previous reviews and approvals.

Note generator 250 may be a hardware computing device that is configured to generate periodic release notes with a summary in natural language of all the changes made to the code in memory device 215. This summary and the changed code can later be communicated back to computing device 105 over network 110. Note generator 250 may save computing resources in several ways: interpreting vast amounts of data, such as code changes, and generating release notes at a higher speed than developers, thus reducing reduces CPU usage and execution time required for tasks; reducing the need for repetitive manual tasks, freeing up developers to work on more resource-intensive tasks; reducing overall memory and CPU usage within a development team, creating concise and clear release notes by sorting through relevant changes; ignoring trivial or unrelated changes, thus saving bandwidth by reducing the amount of unnecessary information transmitted; and ensuring consistent and error-free documentation by applying the same rules and format to release notes, also reducing the time spent reviewing and editing release notes, saving CPU and memory usage.

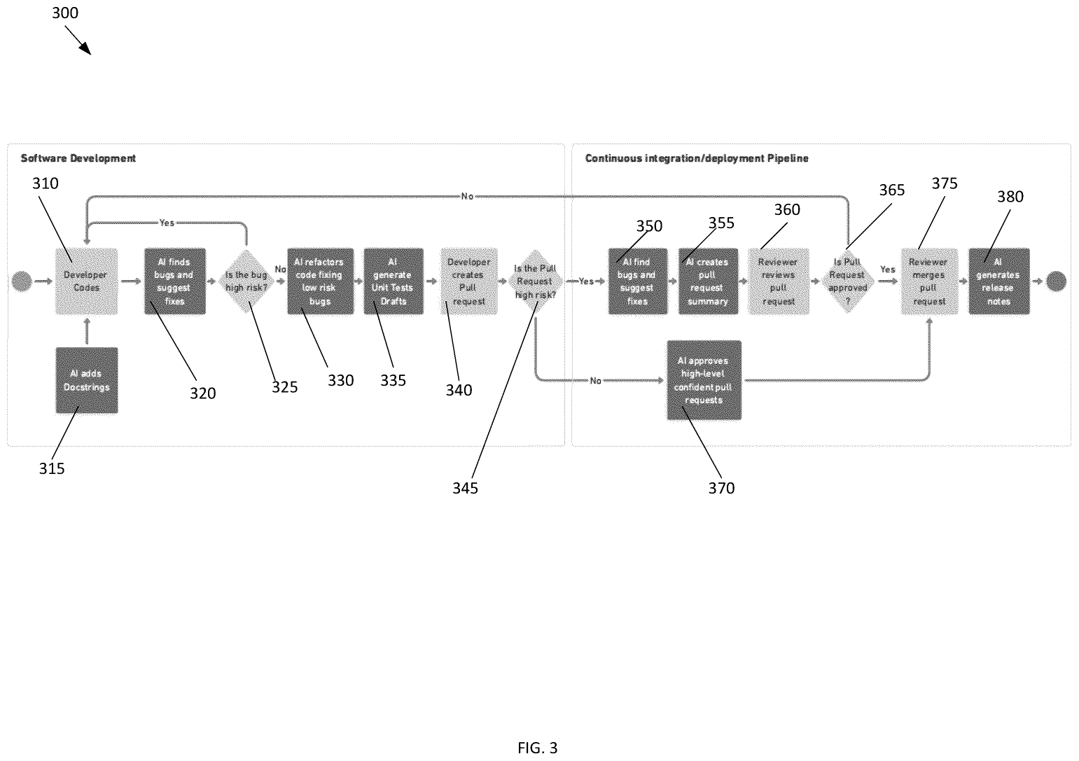

FIG. 3 illustrates a method 300 for a production line of code that leverages AI, according to an embodiment. The operations of method 300 presented below are intended to be illustrative. Method 300 may enable a database schema that can lead to more efficient updates. For example, if the schema is designed to minimize the number of joins needed for common operations, updates can be processed more quickly. Method 300 may also enable high-quality code that implements connection pooling, which reduces the overhead of establishing and tearing down database connections. This can save significant processing power, especially under high load.

In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, a developer may develop code. The code may be a function or file for software based applications, or may be updated portions of code for an already developed codebase stored on a repository within a server. For example, the code developed by the developer may be a backbone of a function for the software-based application. Responsive to developing the code, the developer may push the code onto a production line.

At operation 315, an AI computing device may automatically receive the code developed by the developer on the production line, and provide the developer with docstrings and comments within an Integrated Development Environment (IDE). By utilizing an IDE, the developer may not be required to switch software while developing the code, which may save time and improve the readability of the code.

At operation 320, after the AI computer device has updated the code on the pipeline with docstrings and comments, the AI computing device may propose changes to the code on the pipeline. For example, the AI computing device may determine if bugs are associated with the code, and suggest fixes for the bugs. Furthermore, the AI computing device is provided with the analysis results. Together with the functional and logic mistakes, the AI computing device classifies all issues by risk, such as the risk level may be a low risk, medium risk, or high risk.

At operation 325, before a reviewer reviews that code, the AI computing device may determine the risk level of the bug. Specifically, the AI computing device may identify security issues associated with the code and areas of the code that can be improved, such as code duplication, inefficient algorithms, or poor coding practices. This streamlines the code review process and improves the code quality. If the AI computing device determines that correcting a bug associated with the code has a high-risk or medium-risk level, then the code on the production line may be transmitted back to a developer on a computing device for further review. Furthermore, when transmitting the code back to the computing device, the AI computing device may suggest fixes to the medium and high-risk defects identified to help the developers. This may save time for the developer in reviewing the code and streamline the review process.

At operation 330, if the AI computing device determines that correcting a bug associated with the code has a low risk level, then the generative AI computing device refactors the code on the production line and fixes the low-level risk within the code. Specifically, for bugs with low risk levels, the AI Computing device may automatically refactor the code utilizing the large language models without further input from the developer.

At operation 335, the AI computing device may generate unit test drafts with the code. The unit test drafts may be a way of testing a unit of code. For example, the unit test drafts may be a class, line of code, function, subroutine, method, etc., wherein the AI computing device may determine the unit tests based on the deliverables of the code and technology area associated with the code. In embodiments, the generated unit test drafts may be automatically edited, updated, and are run by the AI computing device each time the pull request is updated. This reduces potential bugs and ensures that the code works properly and can be implemented at a later stage.

At operation 340, a developer using a computing device may initiate a pull request for the results of the unit test drafts for quality control. When a developer creates a pull request, the developer may be asking the repository or database for the software application on the server to merge their code and proposed changes into the main branch of the codebase on the repository on the server before the code on the pipeline is stored within the repository. The pull request may include a description of the changes, as well as documentation and tests generated by the system previously. Each time a developer creates or updates a pull request, unit tests are run, bugs are identified, and instant code refactoring is performed. Once the pull request is created, and received by the AI computing device, the AI computing device may classify the pull request by the confidence level.

At operation 370, if the AI computing device is highly confident with the pull request, wherein a highly confident pull requests may indicate that the code has no bugs or low-risk bugs that can be fixed by the AI computing device refactoring the piece of code (for example, pull requests with simple changes like minor version updates), the AI computing device refactors again the code to fix the minor bugs and approves the pull request. When such pull request is approved by the AI computing device, the client computing device does not receive the approved and updated code and instead the approved and updated code is merged into production at operation 380. This streamlines the code review process and saves time for the reviewer.

At operation 350, for pull requests with low-confidence level, that is to say pull requests with high and medium level risk bugs that cannot be refactored, the AI computing device identifies functional bugs, security issues, runtime inefficiencies, logic mistakes and poor coding practices in the code. The AI computing device may also suggest fixes to the defects identified.

At operation 355, the AI computing device may generate a summary of the low-confidence level pull requests using in natural language, which will be sent to the code reviewer computing device to allow the reviewer context about the code and help the reviewer prioritize their work. This streamlines the code review process and saves time for the reviewer.

At operation 360, the reviewer may review the changes created by the AI computing device to the medium and high-risk level code. Utilizing embodiments and algorithms a number of server requests needed to perform a task, as well as the amount of data that needs to be exchanged can be reduced.

At operation 365, if the reviewer rejects the code changes, the reviewer may provide feedback to the developer. Furthermore, the rejected code may be returned to the developer, and the developer will start typing code to correct and improve the code. The process may begin again at operation 310.

At operation 375, if the reviewer approves the changes to the code, the reviewer may merge the pull request into the codebase hosted on the remote repository.

At operation 380, the AI computing device may generate a release note with a summary using the natural language of all changes done in the repository. This helps developers follow up on the code changes and reviews, improves the readability of the code repository, and improves the overall quality of code, reducing the processing time, and maintenance costs and improving the server performance. In embodiments, method 300 may result in higher quality code, that is optimized for performance, meaning it processes data more efficiently. This can result in smaller amounts of data being sent back and forth between the app and the server. Furthermore, higher-quality code can implement effective data compression techniques, which reduce the size of the data being transmitted. This means that less bandwidth is required to send the same information.

Additionally, the high-quality code can manage concurrency in a way that minimizes conflicts and deadlocks, which can otherwise consume significant processing power to resolve. Efficient transaction management ensures that database updates are committed or rolled back in a way that minimizes the processing power required for maintaining the transaction log and ensuring data consistency.

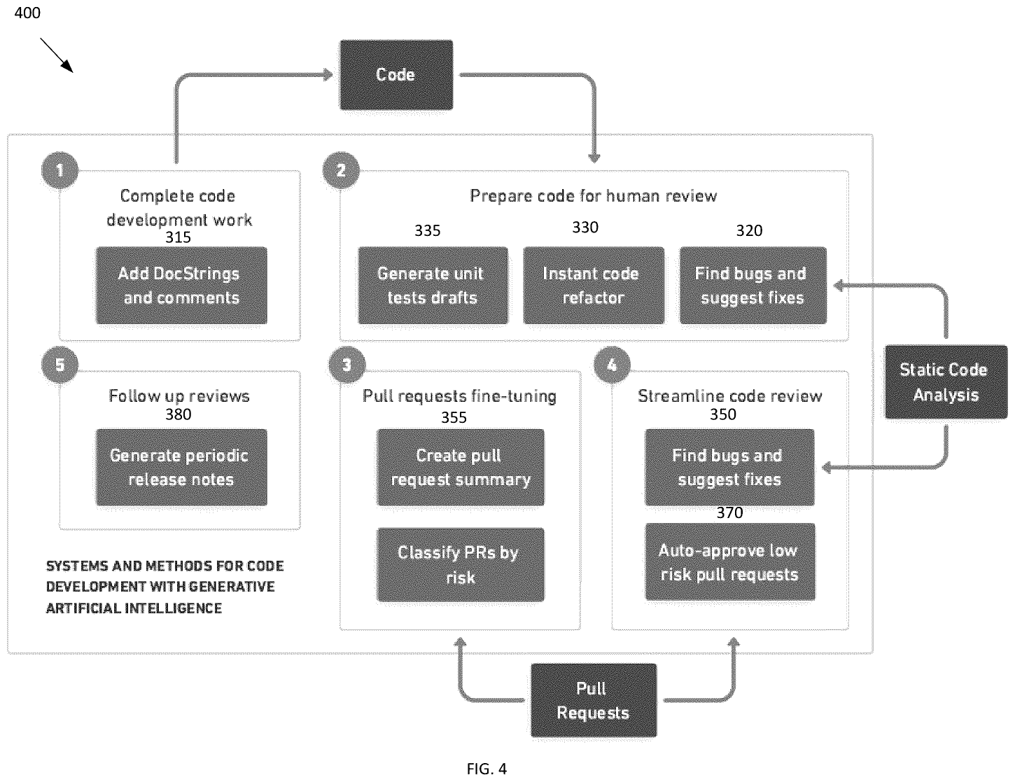

FIG. 4 depicts processes 400 implemented by an AI computing device 140, according to an embodiment. Elements depicted in FIG. 4 may be described above, and for the sake of brevity, a further description of these elements may be omitted.

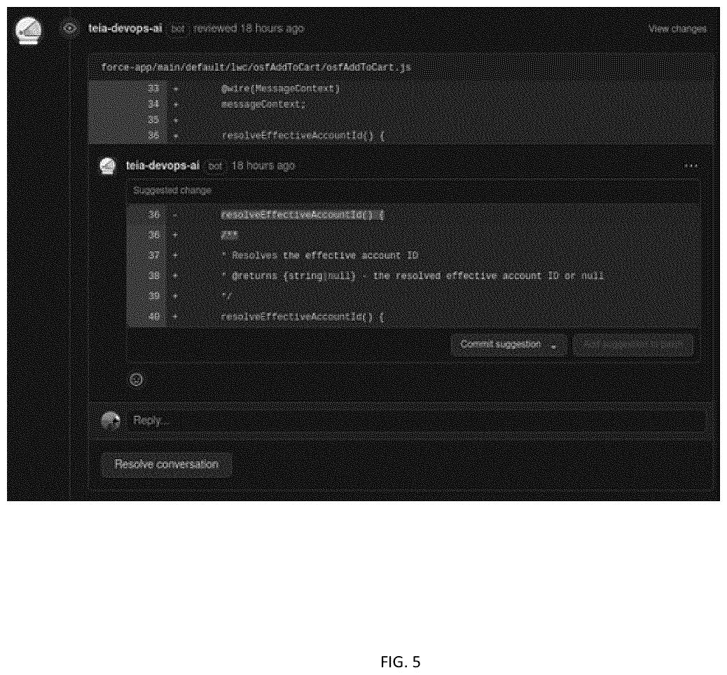

FIG. 5 depicts AI computing device 140 determining a docstring missing and suggesting a docstring for code on a pipeline, according to an embodiment. Elements depicted in FIG. 5 may be described above, and for the sake of brevity, a further description of these elements may be omitted.

In embodiments, AI computing device 140 may determine a docstring missing and suggest a docstring for code at operation 315.

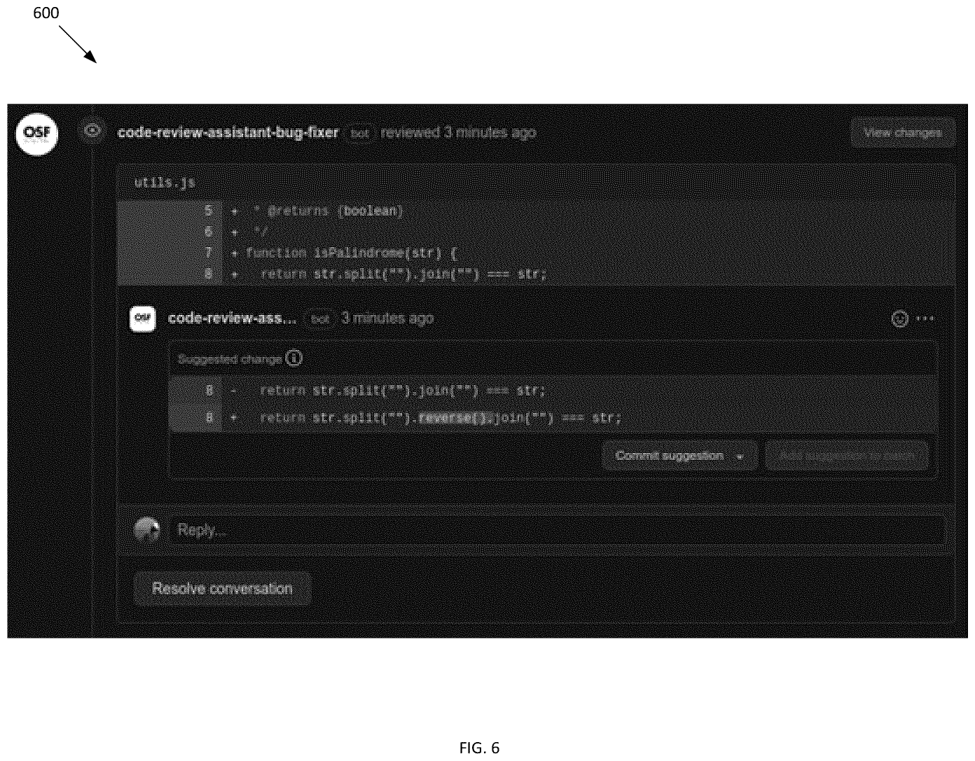

FIG. 6 depicts AI computing device 140 determining a bug and determining a fix for the bug for code on a pipeline, according to an embodiment. Elements depicted in FIG. 6 may be described above, and for the sake of brevity, a further description of these elements may be omitted.

In embodiments, AI computing device 140 may determine a docstring missing and suggest a docstring for code at operation 320.

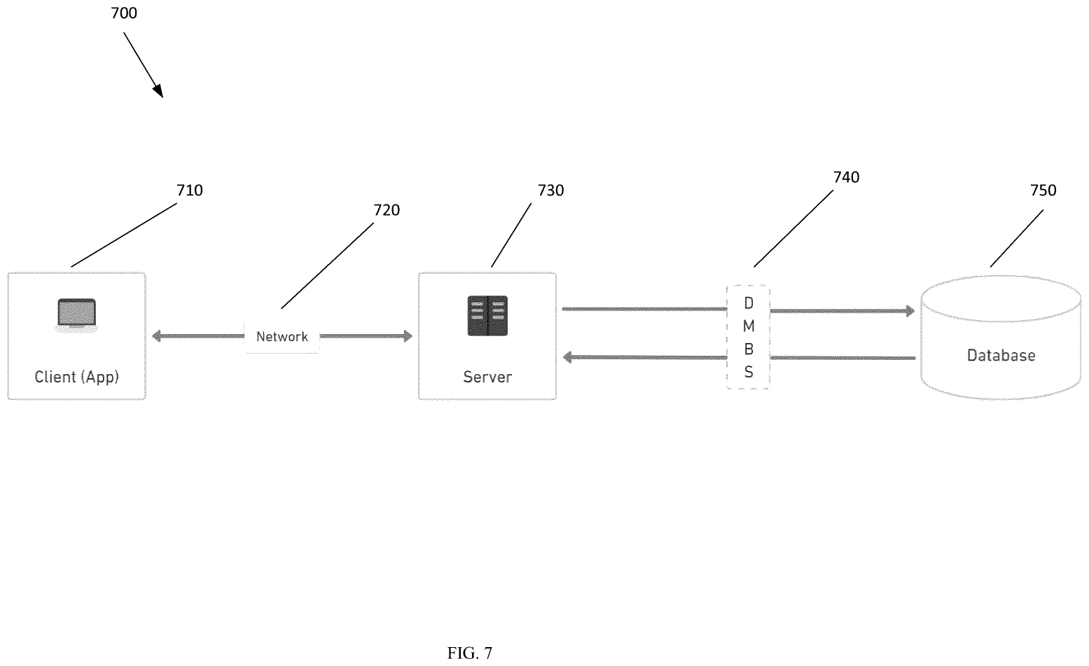

FIG. 7 depicts one topology for code development processes utilizing artificial intelligence. Embodiments may be configured to drive effective and efficient utilization of AI, allowing for more efficient code development to a codebase.

In embodiments, a client application 710 may have its own code that handles a user interface and user interaction. A network 720 may be configured to handle communications between the client application and a server 730. Network 720 may be any medium through which the client application 710 and server 730 may communicate, which may use protocols such as HTTP/HTTPS.

Server 730 may be a remote computer that handles business logic, data processing, and communications with database 750 through database management server 740 which may occur over a specific protocol or API provided by the database management server 740 to create new records or entries to the database 750, retrieve data from database 750, update existing data on database 750, and delete data from the database 750. Server 730 may also be configured to communicate with client application 710 over network 720. In embodiments, server 730 may be a faster server that utilizes less power required to update database 750 due to having higher quality code and more efficient data processing.

Generally, servers 730 have higher maintenance and storage costs associated with client application 710. Processes associated with embodiments utilize CI/CD pipelines to improve server efficiency without altering the enterprise applications themselves. Specifically, embodiments are domain specific with common data stacks. Embodiments operate within the database 750 of the client applications 710 or even the cloud data warehouse, while processes historically merely added capabilities in each application's user interface. Therefore, embodiments summarize the existing data from database 750, create new data in database 750, augment and reformat the data in database 750, structure data in the database 750, synthesize data from the database 750, extract patterns from the data within the database 750, and classify data from the database into defined areas without receiving, or reducing the number of call requests from a developer, which may reduce the amount of bandwidth and memory within database 750.

Database 730 may be a memory repository processed by the code and the content created, stored, retrieved, and manipulated by the client application 710. Utilizing embodiments, database 730 may leverage higher-quality code with well-written database queries that are optimized for efficiency. This means embodiments can retrieve or modify data with fewer operations, reducing the load on the database server's CPU. Furthermore, database 730 may be configured to allow multiple updates to be combined into a single database transaction. This reduces the overhead of processing multiple individual transactions associated with database 730. In embodiments, database 730 may utilize database indexes, which can dramatically speed up data retrieval and reduce the processing power needed for database operations.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments by the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flowcharts and/or block diagrams.

What is claimed is:

1. A method for code development with generative artificial intelligence, the method comprising:
developing code by a developer, the code being associated with a codebase stored on a repository within a server;
receiving, by an artificial intelligence computing device, the developed code;
updating, by the artificial intelligence computing device, the developed code to provide docstrings and comments for the developed code with an Integrated Development Environment;
uploading, by the artificial intelligence computing device,
providing, by the artificial intelligence computing device, proposed changes to the developed code on a pipeline, and providing a risk assessment of the proposed changes to the developed code;
generating, by the artificial intelligence computing device, unit test drafts for the updated code;
merging, by a developer, the updated code into a branch of the codebase on the repository on a server before the updated code on the pipeline is stored within the repository.

2. The method of claim 1, further comprising:
updating branches of the code on the repository within the server via the artificial intelligence device and the developer.

3. The method of claim 2, further comprising:
initiating a pull request for the results of the unit test drafts;
classifying the pull request by confidence level.

4. The method of claim 3, further comprising:
determining a first-level confidence level for the pull request, and
refracting, by the artificial intelligence computing device, the code to fix bugs and approving the pull request.

5. The method of claim 4, further comprising:
determining a second-level confidence level for the pull request, and
reviewing, by a reviewer, changes to the code associated with the pull request.

6. The method of claim 5, further comprising:
merging the code associated with the pull request into a codebase on a remote repository.

7. The method of claim 1, further comprising:
determining, by the artificial intelligence computing device, a missing docstring for the code.

8. The method of claim 1, wherein the developer and the artificial intelligence computing device are configured to create the updated code.
